(19) United States
(12) Patent Application Publication
(10) Pub. No.: US 2005/0269924 A1
(43) Pub. Date: Dec. 8, 2005

(54) Backlight for liquid crystal display

(76) Inventors: Ko-Chia Kao, Pingtung County (TW); Chih-Kuang Chen, Kaohsiung City (TW); Hsin-Wu Lin, Tainan City (TW)

Correspondence Address: David I. Roche;BAKER & McKENZIE, 130 E. Randolph Drive, Chicago, IL, 60601, US

(21) Appl. No.: 10/860,400

(22) Filed: Jun. 3, 2004

(51) Int. Cl. H01J 5/16; H01J 61/38

(52) U.S. Cl. 313/110; 313/634; 313/112

(57) ABSTRACT

A backlight includes a mounting frame, a light-guide plate, a plurality of lamps arranged along the side edges of the light-guide plate, and one or more optical film covering an area of the light-guide plate. The lamps are arranged so that each side edge portion of the light-guide plate approximately faces a lighting area of one lamp. In further configuration of the backlight, the lamps are arranged so that at least two or more lamps overlap each other at one side of the light-guide plate.

### BACKGROUND AND SUMMARY OF THE INVENTION

1. Field of the Invention

The present invention generally relates to a backlight for a liquid crystal display (LCD), and more particularly to the structure of such a backlight device.

2. Description of the Related Art

In transmissive and transflective LCD, a backlight is conventionally used to illuminate the liquid crystal panel from behind, i.e. opposite to the viewer side. Backlight constructions known in the art include direct type backlights and side-lit type backlights. In a direct type backlight, the light source illuminates directly underneath the screen display area. In a side-lit type backlight, the light source illuminates the screen display area at sides of the liquid crystal panel.

U.S. Pat. No. 6,339,418 issued to Kitagawa discloses an example of side-lit type backlight known in the art, the disclosure of which is incorporated herein by reference. The known side-lit backlight includes a tubular fluorescent lamp mounted at a side of the light-guide plate. The lamp can be configured to extend along three sides (U-shape lamp) of the light-guide plate that redirects light irradiated from the lamp.

In other conventional side-lit backlights, several lamps can be also placed at the sides of the light-guide plate to increase the illumination of the liquid crystal panel. FIG. 1 is a planar view of another side-lit backlight known in the art. The illustrated backlight 50 includes a light-guide plate 10 along the sides of which are placed L-shaped lamps 20. Two L-shaped lamps 20 are usually placed to cover the four sides of the rectangular light-guide plate 10, and respectively terminate in electrode terminals 22 at two corners 12 of the light-guide plate 10. The electrode terminals 22 do not irradiate light and constitute dark areas of the lamps 20. As a result, at least two corner areas 12 of the light-guide plate 10 are not adequately covered by lamp lighting areas and thus do not receive sufficient light irradiation.

To cure the above deficiency, a conventional approach consists in placing a reflective pattern (not shown) at the bottom of the light-guide plate 10. However, this arrangement still does not provide satisfactory results. Therefore, there is presently a need for an improved backlight that can provide enhanced illumination over the entire display screen.

### SUMMARY OF THE INVENTION

The present application describes a liquid crystal display and a backlight structure for liquid crystal display. In one embodiment, the liquid crystal display comprises a liquid crystal panel, and a backlight including a light-guide plate and a plurality of lamps arranged along the side edges of the light-guide plate, wherein the lamps are arranged so as to surround the sides of the light-guide plate.

In one embodiment, the backlight includes lamps arranged so that at least two or more lamps overlap each other at one side of the light-guide plate. In another embodiment, the backlight includes lamps arranged so that each side edge portion of the light-guide plate approximately faces a lighting area of one lamp.

In one particular embodiment, the light-guide plate has a generally rectangular shape and the lamps are formed in a L-shape. In another embodiment, the lamps include fluorescent lamps.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1 is a schematic planar view of a backlight known in the art;

FIG. 2A is an exploded view of the assembly of a LCD system incorporating a backlight according to an embodiment of the invention;

FIG. 2B is a planar view of a backlight according to an embodiment of the invention;

FIG. 2C is a schematic view of a fluorescent lamp implemented in a backlight according to an embodiment of the invention; and

FIG. 2D is a cross-sectional view taken along section 2D of FIG. 2B.

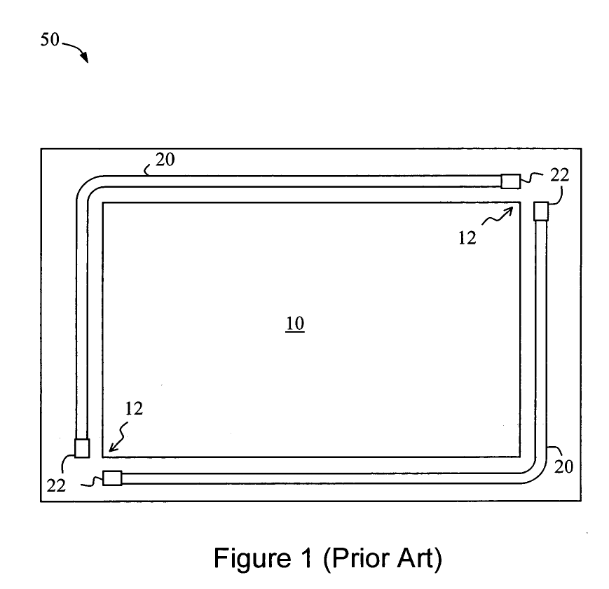

### DETAILED DESCRIPTION OF THE EMBODIMENT(S)

The applicants have conducted testing on conventional LCD systems, and have observed that peripheral areas and in particular corner areas of the display screen experience lower brightness. The application describes a backlight for a liquid crystal display system that can improve the backlight illumination.

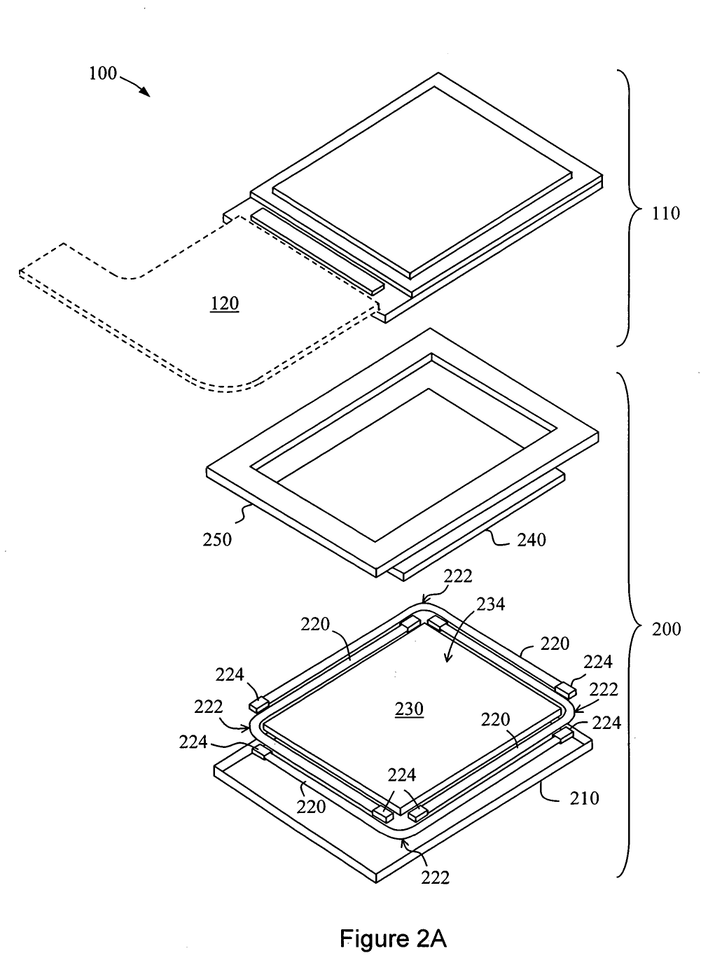

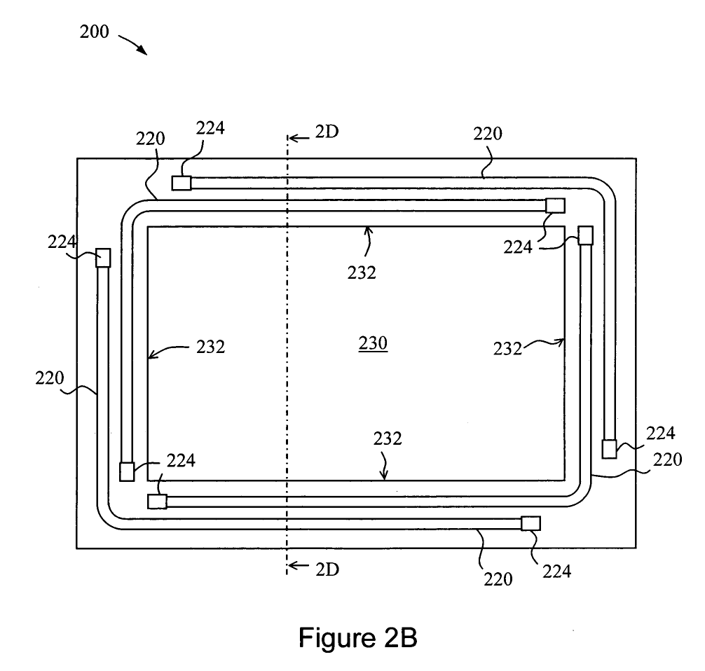

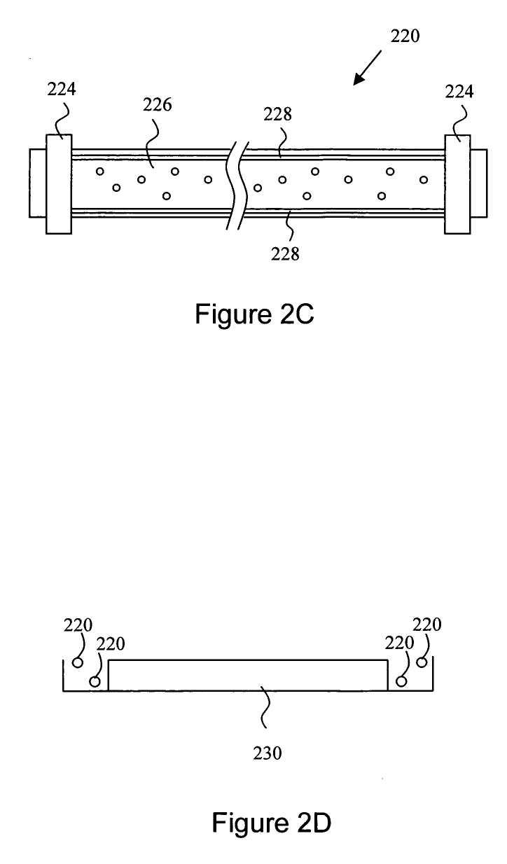

FIG. 2A is an exploded view of a LCD system incorporating the assembly of a backlight according to an embodiment of the invention, while FIG. 2B is a planar view of a backlight according to an embodiment of the invention. The LCD 100 includes the assembly of a liquid crystal panel 110 and a backlight 200. The liquid crystal panel 110 can be formed of a conventional multi-layer structure including a liquid crystal layer sandwiched between two substrates (not shown). A driver printed circuit 120 can couple with the liquid crystal panel 110 to drive image displaying.

The backlight 200 includes a frame 210 in which lamps 220 are placed at sides of a light-guide plate 230. Optical films 240 including light diffusing and/or prismatic films can be mounted to cover the light-guide plate 230. A light-shielding layer 250 is further laid to cover the area occupied by the lamps 220 at the periphery of the optical films 240 and light-guide plate 230 to prevent light leakage.

In an embodiment, the lamps 220 can be fluorescent lamps. As shown in FIG. 2C, a fluorescent lamp 220 encloses a discharge gas 226 that, upon stimulation by electrons produced by the application of a voltage potential between electrodes 224, produces a radiation that strikes a fluorescent material 228. As a result, the stimulated fluorescent material 228 produces visible light. Such construction of fluorescent lamp is per se known in the art and is described only for purposes of illustration. It is understood that the inventive features described herein are intended to be generally compatible with diverse types of lamp structures.

Light irradiated from the lamps 220 impinges on the sides 232 of the light-guide plate 230 and then is redirected and emerges through the major surface 234 of the light-guide plate 230 towards the liquid crystal panel 110. The liquid crystal panel 110 is driven via the driver printed circuit 120 to modulate the light irradiated from the backlight 200 to display images.

In the example of FIGS. 2A and 2B, the light-guide plate 230 exemplary has a generally rectangular profile, and each lamp 220 is formed in a L-shape including a bent portion 222 and terminating in electrodes 224. To ensure that the entire display area of the liquid crystal panel 110 receives adequate illumination, the lamps 220 are placed overlapping one another so that every side edge portions of the light-guide plate 230 approximately faces one lighting area of one lamp 220.

In the illustrated embodiment, a number of four L-shaped lamps 220 overlap one another to surround the four sides of the rectangular light-guide plate 230, each corner of the light-guide plate 230 facing at least one bent portion 222 of a lamp 220. As shown in FIG. 2D, the lamps 220 can be laid in different planes parallel to the light-guide plate 230 so that one lamp 220 does not obstruct the light path irradiated by another adjacent lamp 220.

This placement of the backlight lamps enables any side edge portions of the light-guide plate 230 to receive sufficient light irradiation from the lamps 200. As a result, the occurrence of areas of reduced light brightness can be prevented.

It is understood that the foregoing overlapping arrangement illustrates only a particular way of placing the backlight lamps along the sides of the light-guide, and many variant structures can be implemented to have each side edge portion of the light-guide plate face a lighting area of one lamp.

Realizations in accordance with the present invention therefore have been described in the context of particular embodiments. These embodiments are meant to be illustrative and not limiting. Many variations, modifications, additions, and improvements are possible. Accordingly, plural instances may be provided for components described herein as a single instance. Additionally, structures and functionality presented as discrete components in the exemplary configurations may be implemented as a combined structure or component. These and other variations, modifications, additions, and improvements may fall within the scope of the invention as defined in the claims that follow.

1. A backlight for liquid crystal display, comprising:
a mounting frame;
a light-guide plate;
a plurality of lamps arranged along side edges of the light-guide plate, wherein the lamps are arranged so that at least two or more lamps overlap each other at one side of the light-guide plate; and
one or more optical film covering an area of the light-guide plate.

2. The backlight according to claim 1, wherein the light-guide plate has a generally rectangular shape.

3. The backlight according to claim 1, wherein the lamps include lamps respectively formed in a L-shape.

4. The backlight according to claim 1, wherein the lamps are placed according to an arrangement in which each side edge portion of the light-guide plate approximately faces a lighting area of one lamp.

5. The backlight according to claim 1, further comprising a light-shielding layer covering a peripheral area of the light-guide plate to prevent light leakage.

6. The backlight according to claim 1, wherein the lamps include fluorescent lamps.

7. A backlight for liquid crystal display, comprising:
a mounting frame;
a light-guide plate;
a plurality of lamps arranged along side edges of the light-guide plate, wherein the lamps are arranged so that each side edge portion of the light-guide plate approximately faces a lighting area of one lamp; and
one or more optical film covering an area of the light-guide plate.

8. The backlight according to claim 7, wherein the light-guide plate has a generally rectangular shape.

9. The backlight according to claim 7, wherein the lamps include lamps respectively formed in a L-shape.

10. The backlight according to claim 7, wherein the lamps are placed according to an arrangement in which at least two or more lamps overlap each other at one side of the light-guide plate.

11. The backlight according to claim 7, further comprising a light-shielding layer covering a peripheral area of the light-guide plate to prevent light leakage.

12. The backlight according to claim 7, wherein the lamps include fluorescent lamps.

13. A liquid crystal display, comprising:
a liquid crystal panel; and
a backlight including a light-guide plate and a plurality of lamps arranged along the side edges of the light-guide plate, wherein the lamps are arranged so as to surround the sides of the light-guide plate.

14. The liquid crystal display according to claim 13, wherein the lamps are arranged so that at least two or more lamps overlap each other at one side of the light-guide plate.

15. The liquid crystal display according to claim 13, wherein the lamps are arranged so that each side edge portion of the light-guide plate approximately faces a lighting area of one lamp.

16. The liquid crystal display according to claim 13, wherein the light-guide plate has a generally rectangular shape.

17. The liquid crystal display according to claim 13, wherein the lamps include lamps respectively formed in a L-shape.

18. The liquid crystal display according to claim 13, further comprising a light-shielding layer covering an area peripheral to the light-guide plate to prevent light leakage.

19. The liquid crystal display according to claim 13, wherein the lamps include fluorescent lamps.
